(19) United States
(12) Patent Application Publication
(10) Pub. No.: US 2016/0092421 A1
(43) Pub. Date: Mar. 31, 2016

(54) Text Editing Method and Apparatus, and Server

(71) Applicant: Huawei Technologies Co., Ltd., Shenzhen (CN)

(72) Inventors: Jie Zhang, Shenzhen (CN); Yibo Zhang, Shenzhen (CN)

(21) Appl. No.: 14/960,733

(22) Filed: Dec. 7, 2015

Related U.S. Application Data
(63) Continuation of application No. PCT/CN2014/076840, filed on May 6, 2014.

(30) Foreign Application Priority Data
Sep. 11, 2013 (CN) 201310412377.3

(51) Int. Cl. G06F 17/24; G06F 3/0484; G06F 3/0482; G06F 17/27

(52) U.S. Cl. CPC G06F 17/24; G06F 17/277; G06F 17/2785; G06F 3/04842; G06F 3/0482

(57) ABSTRACT

A text editing method and apparatus, and a server. The method includes acquiring a to-be-edited text; segmenting content in the to-be-edited text into word chunks; determining a to-be-replaced word chunk in the word chunks; acquiring at least one candidate word chunk similar to the to-be-replaced word chunk, and generating a candidate word chunk list; displaying the candidate word chunk list; and when an operation instruction that a user selects a candidate word chunk in the displayed candidate word chunk list is acquired, replacing the selected candidate word chunk with the to-be-replaced word chunk, to complete text editing. The embodiments of the present disclosure resolve a technical problem in the prior art that editing a text on a word basis leads to inaccurate cursor positioning, and improve user experience.

### CROSS-REFERENCE TO RELATED APPLICATIONS

This application is a continuation of International Application No. PCT/CN2014/076840, filed on May 6, 2014, which claims priority to Chinese Patent Application No. 201310412377.3, filed on Sep. 11, 2013, both of which are hereby incorporated by reference in their entireties.

### TECHNICAL FIELD

The present disclosure relates to the field of terminal technologies, and in particular, to a text editing method and apparatus, and a server.

### BACKGROUND

With the rapid development of mobile electronic devices, people use a touchscreen more frequently to perform word input and word editing. Not only new text content can be written, but also existing text content can be edited again.

However, in the prior art, editing operations on text content are cumbersome. For example, if a word or a sentence in a text needs to be deleted, a user needs to move a finger to find a focal point, and then tap a delete button; for another example, if content in a text needs to be selected, a position that is to be selected on the screen needs to be tapped, and after a prompt box appears, an operation mode is selected by tapping, and then a finger of a user moves to select a range, thereby selecting the content in the text.

During research and practice of the prior art, the inventor of the present disclosure finds that an existing text editing manner is performing text editing on a “word” basis, that is, when a text is edited, cursor positioning is performed by using a finger, which is inconvenient for a user to operate because the finger is thick and the word spacing is small, and also improves user experience.

### SUMMARY

Embodiments of the present disclosure provide a text editing method and apparatus, and a server, so as to resolve a technical problem in the prior art that editing a text on a word basis leads to inaccurate cursor positioning and degrades user experience.

In order to resolve the foregoing technical problem, the embodiments of the present disclosure disclose the following technical solutions.

A first aspect provides a text editing method, where the method includes acquiring a to-be-edited text; segmenting content in the to-be-edited text into word chunks; determining a to-be-replaced word chunk in the word chunks; acquiring at least one candidate word chunk similar to the to-be-replaced word chunk, and generating a candidate word chunk list; displaying the candidate word chunk list; and when an operation instruction that a user selects a candidate word chunk in the displayed candidate word chunk list is acquired, replacing the selected candidate word chunk with the to-be-replaced word chunk, to complete text editing.

In a first possible implementation manner of the first aspect, the segmenting content in the to-be-edited text into word chunks includes segmenting the content in the to-be-edited text into word chunks according to idioms, common words, and semantic and pragmatic similarities.

With reference to the first aspect or the first possible implementation manner of the first aspect, in a second possible implementation manner, the determining a to-be-replaced word chunk in the word chunks includes determining the to-be-replaced word chunk in the word chunks according to a received replacement operation instruction of the user.

With reference to the first aspect or the first or the second possible implementation manner of the first aspect, in a third possible implementation manner, the acquiring at least one candidate word chunk similar to the to-be-replaced word chunk, and generating a candidate word chunk list includes searching a word chunk library for the at least one candidate word chunk similar to the to-be-replaced word chunk; and arranging the found at least one candidate word chunk together, and generating the candidate word chunk list.

With reference to the first aspect or the first, the second, or the third possible implementation manner of the first aspect, in a fourth possible implementation manner, the displaying the candidate word chunk list includes displaying the candidate word chunk list in a text form below the to-be-replaced word chunk.

With reference to the first aspect or the first, the second, the third, or the fourth possible implementation manner of the first aspect, in a fifth possible implementation manner, the method further includes, if no candidate word chunk similar to the to-be-replaced word chunk is acquired, receiving a replacement text that is input by the user; and replacing the to-be-replaced word chunk in the word chunks with the replacement text, to complete text editing.

With reference to the first aspect or the first, the second, the third, the fourth, or the fifth possible implementation manner of the first aspect, in a sixth possible implementation manner, the method further includes calculating semantic and pragmatic similarities of a training text set on a chunk basis, and obtaining corresponding word chunks, where the word chunks form the word chunk library.

A second aspect provides a text editing apparatus, including a first acquiring unit configured to acquire a to-be-edited text; a segmentation unit configured to segment content in the to-be-edited text into word chunks; a determining unit configured to determine a to-be-replaced word chunk in the word chunks; a second acquiring unit configured to acquire at least one candidate word chunk similar to the to-be-replaced word chunk; a generation unit configured to generate a candidate word chunk list according to the at least one candidate word chunk acquired by the second acquiring unit; a display unit configured to display the candidate word chunk list; and an editing unit configured to, when an operation instruction that a user selects a candidate word chunk in the candidate word chunk list is acquired, replace the selected candidate word chunk with the to-be-replaced word chunk, to complete text editing.

In a first possible implementation manner of the second aspect, the segmentation unit is configured to segment the content in the to-be-edited text into the word chunks according to idioms and semantic and pragmatic similarities.

With reference to the second aspect or the first possible implementation manner of the second aspect, in a second possible implementation manner, the determining unit is configured to determine the to-be-replaced word chunk in the word chunks according to a received replacement operation instruction of the user.

With reference to the second aspect or the first or the second possible implementation manner of the second aspect, in a third possible implementation manner, the second acquiring unit is configured to search a word chunk library for the at least one candidate word chunk similar to the to-be-replaced word chunk; and the generation unit is configured to arrange the found at least one candidate word chunk together, and generate the candidate word chunk list.

With reference to the second aspect or the first, the second, or the third possible implementation manner of the second aspect, in a fourth possible implementation manner, the display unit is configured to display the candidate word chunk list in a text form below the to-be-replaced word chunk.

With reference to the second aspect or the first, the second, the third, or the fourth possible implementation manner of the second aspect, in a fifth possible implementation manner, the apparatus further includes a receiving unit configured to, if the second acquiring unit acquires no candidate word chunk similar to the to-be-replaced word chunk, receive a replacement text that is input by the user; and a replacement unit configured to replace the to-be-replaced word chunk in the word chunks with the replacement text, to complete text editing.

With reference to the second aspect or the first, the second, the third, the fourth, or the fifth possible implementation manner of the second aspect, in a sixth possible implementation manner, the apparatus further includes a storage unit connected to the second acquiring unit, and configured to store multiple word chunks, where the word chunks are obtained by calculating semantic and pragmatic similarities of a training text set on a chunk basis.

A third aspect provides a text editing apparatus, including a similarity calculation unit configured to calculate semantic and pragmatic similarities of a training text set on a chunk basis to obtain word chunks; a storage unit configured to store the word chunks obtained through calculation by the similarity calculation unit; a user interface unit configured to acquire a to-be-edited text of a user, segment content in the to-be-edited text into word chunks, and determine a to-be-replaced word chunk in the word chunks; and a candidate searching unit configured to find at least one candidate word chunk similar to the to-be-replaced word chunk, generate a candidate word chunk list, and display the candidate word chunk list, where the user interface unit is further configured to, when an operation instruction that the user selects a candidate word chunk in the displayed candidate word chunk list is acquired, replace the selected candidate word chunk with the to-be-replaced word chunk, to complete text editing.

In a first possible implementation manner of the third aspect, the user interface unit is further configured to, when the candidate searching unit finds no candidate word chunk similar to the to-be-replaced word chunk, receive a replacement text that is input by the user, and replace the to-be-replaced word chunk in the word chunks with the replacement text, to complete text editing.

A fourth aspect provides a server, including a word chunk library configured to store word chunks, where the word chunks are obtained by calculating semantic and pragmatic similarities of a training text set on a chunk basis; a transceiver configured to acquire a to-be-edited text; and a processor configured to segment content in the to-be-edited text into word chunks, and determine a to-be-replaced word chunk in the word chunks, where the transceiver is further configured to acquire at least one candidate word chunk similar to the to-be-replaced word chunk; the processor is further configured to generate a candidate word chunk list according to the at least one candidate word chunk acquired by the transceiver, and display the candidate word chunk list; the transceiver is further configured to receive an operation instruction that a user selects a candidate word chunk in the displayed candidate word chunk list; and the processor is further configured to, when the transceiver receives the operation instruction, replace the selected candidate word chunk with the to-be-replaced word chunk, to complete text editing.

In a first possible implementation manner of the fourth aspect, the transceiver is further configured to, when the candidate searching unit finds no candidate word chunk similar to the to-be-replaced word chunk, receive a replacement text that is input by the user; and the processor is further configured to replace the to-be-replaced word chunk in the word chunks with the replacement text, to complete text editing.

It may be known from the foregoing technical solutions that, in the embodiments of the present disclosure, a to-be-edited text is segmented into multiple word chunks, a word chunk needing to be replaced is determined, a candidate word chunk list for the word chunk needing to be replaced is acquired, and the candidate word chunk list is displayed to a user, so that when an operation instruction that the user selects a candidate word chunk in the displayed candidate word chunk list is received, the word chunk needing to be replaced is automatically replaced with the selected candidate word chunk. That is, in the embodiments of the present disclosure, text content needing to be edited is positioned on a chunk basis, which resolves a technical problem in the prior art that editing a text on a word basis leads to inaccurate cursor positioning performed by using a finger and makes it inconvenient for a user to operate, and improves user experience.

### BRIEF DESCRIPTION OF THE DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a flowchart of a text editing method according to an embodiment of the present disclosure;

FIG. 2A is a schematic diagram of simultaneously displaying, in different colors, word chunks obtained by segmenting a to-be-edited text according to an embodiment of the present disclosure;

FIG. 2B is a schematic diagram of simultaneously displaying, in one color, word chunks obtained by segmenting a to-be-edited text according to an embodiment of the present disclosure;

FIG. 3 is a schematic diagram of displaying a candidate word chunk list for a to-be-replaced word chunk in a to-be-edited text according to an embodiment of the present disclosure;

FIG. 4 is a schematic structural diagram of a text editing apparatus according to an embodiment of the present disclosure;

FIG. 5 is another schematic structural diagram of a text editing apparatus according to an embodiment of the present disclosure; and

FIG. 6 is a schematic structural diagram of a server according to an embodiment of the present disclosure.

### DETAILED DESCRIPTION

The following clearly describes the technical solutions in the embodiments of the present disclosure with reference to the accompanying drawings in the embodiments of the present disclosure. The described embodiments are merely some rather than all of the embodiments of the present disclosure. All other embodiments obtained by a person of ordinary skill in the art based on the embodiments of the present disclosure without creative efforts shall fall within the protection scope of the present disclosure.

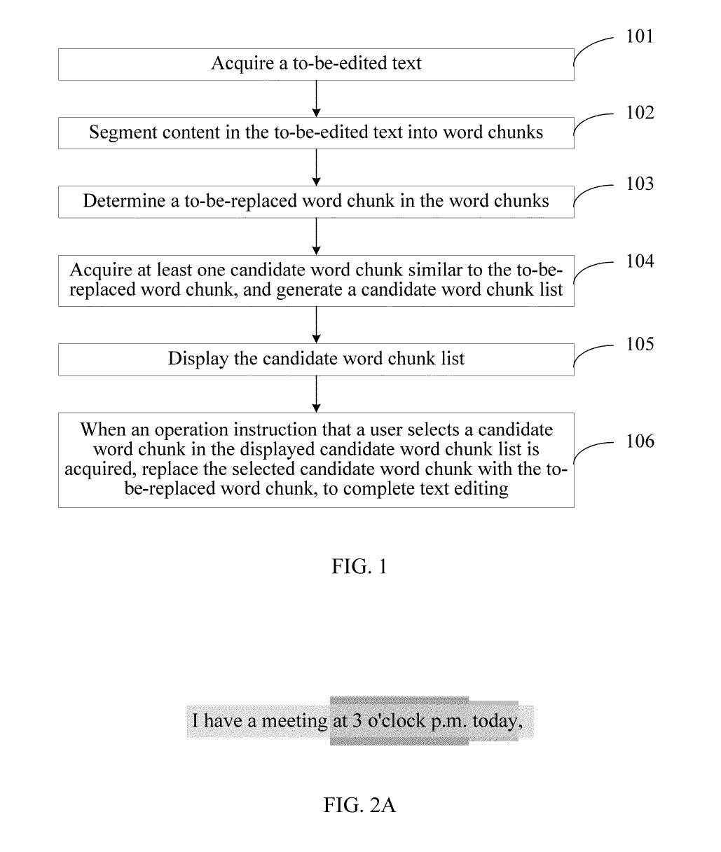

Referring to FIG. 1, FIG. 1 is a flowchart of a text editing method according to an embodiment of the present disclosure. The method includes the following steps.

Step 101: Acquire a to-be-edited text.

A server acquires, by using a man-machine interface, a to-be-edited text that is input by a user, where the to-be-edited text may also be referred to as a text to be processed. Content in the to-be-edited text is, for example, “I have a meeting at 3 o'clock p.m. today, and cannot go to pick you up”, and is certainly not limited thereto.

Step 102: Segment content in the to-be-edited text into word chunks.

In this step, the server segments the content in the to-be-edited text into word chunks. One segmentation manner is segmenting the content in the to-be-edited text into word chunks according to idioms, common words, and semantic and pragmatic similarities. For example, “I have a meeting at 3 o'clock p.m. today, and cannot go to pick you up” is segmented into multiple word chunks, which are: “I”, “have a meeting”, “at 3 o'clock p.m. today”, “and”, “cannot”, “go to”, and “pick you up”. Certainly, the present disclosure is not limited to this segmentation manner, and another segmentation manner may also be used. For another example, “I have a meeting at 3 o'clock p.m. today, and cannot go to pick you up” is segmented into: “I”, “have a meeting”, “at 3 o'clock p.m.”, “today”, “and”, “cannot”, “go to”, and “pick you up”.

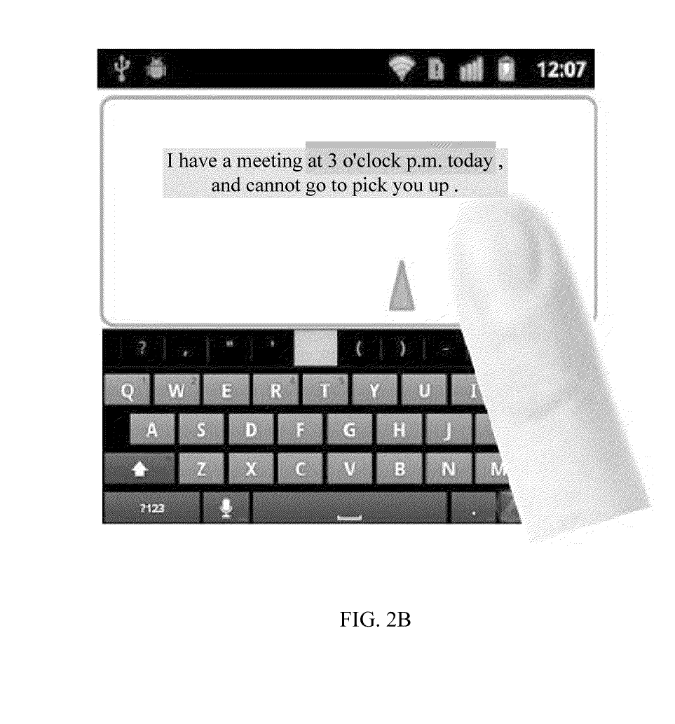

In this embodiment, the word chunks obtained after segmentation may be simultaneously displayed in one color for the user to select, or may be simultaneously displayed in different colors for the user to select. For details, refer to FIG. 2A and FIG. 2B, where FIG. 2A is a schematic diagram of simultaneously displaying, in different colors, word chunks obtained by segmenting a to-be-edited text according to an embodiment of the present disclosure, and FIG. 2B is a schematic diagram of simultaneously displaying, in one color, word chunks obtained by segmenting a to-be-edited text according to an embodiment of the present disclosure. However, in FIG. 2A and FIG. 2B, different colors are displayed by using sizes of gray blocks.

Step 103: Determine a to-be-replaced word chunk in the word chunks.

In this step, the to-be-replaced word chunk in the word chunks is determined according to a received replacement operation instruction of the user, that is, the server receives, by using the man-machine interface, the replacement operation instruction that is input by the user, and then determines the to-be-replaced word chunk in the word chunks according to the replacement operation instruction.

With reference to the foregoing example, assuming that the server receives an instruction that the user intends to replace the word chunk “have a meeting” or intends to replace the word chunk “3 o'clock p.m. today”, the server sets “have a meeting” or “3 o'clock p.m. today” as the to-be-replaced word chunk.

Assuming that “3 o'clock p.m. today” is set as the to-be-replaced word chunk in this embodiment, refer to FIG. 2B for a schematic diagram displayed to the user, and in FIG. 2B, an example of a to-be-edited text of the to-be-replaced word chunk (that is, 3 o'clock p.m. today) is also displayed on a chunk basis.

Step 104: Acquire at least one candidate word chunk similar to the to-be-replaced word chunk, and generate a candidate word chunk list.

In this step, after the to-be-replaced word chunk is determined in the foregoing step, the server searches a word chunk library for the at least one candidate word chunk similar to the to-be-replaced word chunk; and arranges the found at least one candidate word chunk together, and generates the candidate word chunk list.

Multiple word chunks stored in the word chunk library are obtained by calculating semantic and pragmatic similarities of a training text set on a chunk basis, and the multiple word chunks form the word chunk library.

For example, it is found in the word chunk library that candidate word chunks for “have a meeting” are candidate word chunks such as “at a meeting”, “have a class”, “very busy”, and “not available”. For another example, it is found that candidate word chunks for “3 o'clock p.m. today” are candidate word chunks such as “all day long”, “this week”, “this month”, “recently”, and “all the time”. Then, all the found candidate word chunks for each to-be-replaced word chunk are arranged together, and a candidate word chunk list is generated.

Step 105: Display the candidate word chunk list.

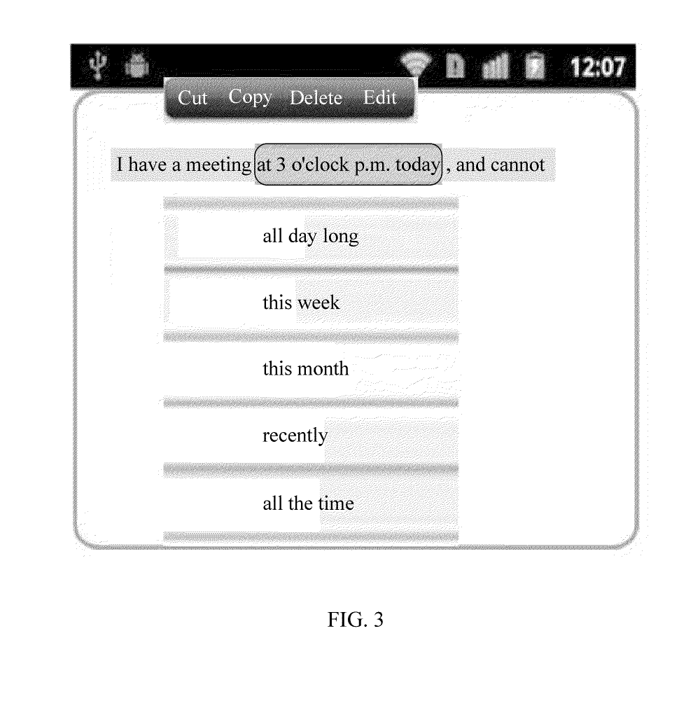

In this step, one display manner is displaying the candidate word chunk list in a text form below the to-be-replaced word chunk, which is shown in FIG. 3. FIG. 3 is a schematic diagram of displaying a candidate word chunk list for a to-be-replaced word chunk in a to-be-edited text according to an embodiment of the present disclosure. In this embodiment, a candidate word chunk list for the to-be-replaced word chunk “at 3 o'clock p.m. today” is displayed, and the candidate word chunk list includes: “all day long”, “this week”, “this month”, “recently”, and “all the time”, which is shown in FIG. 3.

The display manner is not limited to the text display manner, and may also be another display manner, which is not limited in this embodiment.

In this embodiment of the present disclosure, an operation menu of “candidate operations” and “candidate text chunks” for one to-be-replaced word chunk or multiple continuous to-be-replaced word chunks may be displayed for the user to tap.

Step 106: When an operation instruction that a user selects a candidate word chunk in the displayed candidate word chunk list is acquired, replace the selected candidate word chunk with the to-be-replaced word chunk, to complete text editing.

Optionally, in this embodiment, in order to handle a case in which no candidate word chunk similar to the to-be-replaced word chunk exists in the word chunk library, the method may further include, if no candidate word chunk similar to the to-be-replaced word chunk is acquired, receiving a replacement text that is input by the user, and replacing the to-be-replaced word chunk in the word chunks with the replacement text, to complete text editing.

When the server receives, by using the man-machine interface, an operation instruction that the user selects a candidate word chunk in the displayed candidate word chunk list, for example, receives an operation instruction of “all day long”, the selected candidate word chunk is replaced with the to-be-replaced word chunk, to complete text editing. Certainly, an edited text may further be displayed.

In this embodiment of the present disclosure, a to-be-edited text is segmented into multiple word chunks, a word chunk needing to be replaced is determined, a candidate word chunk list for the word chunk needing to be replaced is acquired, and the candidate word chunk list is displayed to a user, so that when an operation instruction that the user selects a candidate word chunk in the displayed candidate word chunk list is received, the word chunk needing to be replaced is automatically replaced with the selected candidate word chunk. That is, in this embodiment of the present disclosure, text content needing to be edited is positioned on a chunk basis, which resolves a technical problem in the prior art that editing a text on a word basis leads to inaccurate cursor positioning performed by using a finger and makes it inconvenient for a user to operate, and improves user experience.

In addition, in this embodiment of the present disclosure, the text content needing to be edited is positioned on a chunk basis, which reduces input operations of the user, improves a text input speed, and therefore improves text editing efficiency.

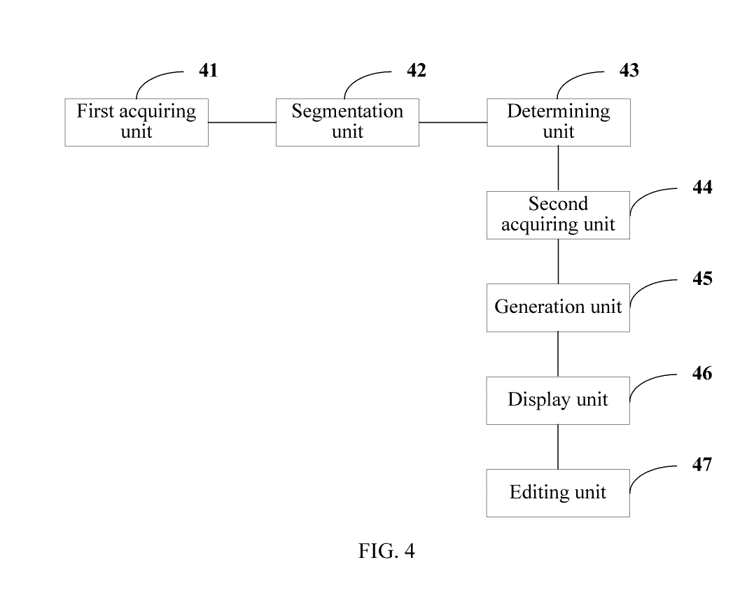

Based on the implementation process of the foregoing method, an embodiment of the present disclosure further provides a text editing apparatus. A schematic structural diagram of the text editing apparatus is shown in FIG. 4, and the apparatus includes a first acquiring unit 41, a segmentation unit 42, a determining unit 43, a second acquiring unit 44, a generation unit 45, a display unit 46, and an editing unit 47, where the first acquiring unit 41 is configured to acquire a to-be-edited text; the segmentation unit 42 is configured to segment content in the to-be-edited text into word chunks, and is configured to segment the content in the to-be-edited text into word chunks according to idioms and semantic and pragmatic similarities; the determining unit 43 is configured to determine a to-be-replaced word chunk in the word chunks, and is configured to determine the to-be-replaced word chunk in the word chunks according to a received replacement operation instruction of a user; the second acquiring unit 44 is configured to acquire at least one candidate word chunk similar to the to-be-replaced word chunk, and is configured to search a word chunk library for the at least one candidate word chunk similar to the to-be-replaced word chunk; the generation unit 45 is configured to generate a candidate word chunk list according to the at least one candidate word chunk acquired by the second acquiring unit, and is configured to arrange the found at least one candidate word chunk together, and generate the candidate word chunk list; the display unit 46 is configured to display the candidate word chunk list, and is configured to display the candidate word chunk list in a text form below the to-be-replaced word chunk; and the editing unit 47 is configured to, when an operation instruction that the user selects a candidate word chunk in the candidate word chunk list is acquired, replace the selected candidate word chunk with the to-be-replaced word chunk, to complete text editing.

Optionally, in another embodiment, this embodiment is based on the foregoing embodiment, and the apparatus may further include a receiving unit and a replacement unit, where the receiving unit is configured to, if the second acquiring unit acquires no candidate word chunk similar to the to-be-replaced word chunk, receive a replacement text that is input by the user; and the replacement unit is configured to replace the to-be-replaced word chunk in the word chunks with the replacement text, to complete text editing.

Optionally, in another embodiment, this embodiment is based on the foregoing embodiment, and the apparatus may further include a storage unit connected to the second acquiring unit, and configured to store multiple word chunks, where the word chunks are obtained by calculating semantic and pragmatic similarities of a training text set on a chunk basis.

Optionally, the apparatus may be integrated in a server for a terminal, or may be integrated in a mobile terminal, such as a mobile phone.

For details about implementation processes of functions and effects of the units in the apparatus, refer to the implementation processes of the corresponding steps in the foregoing method.

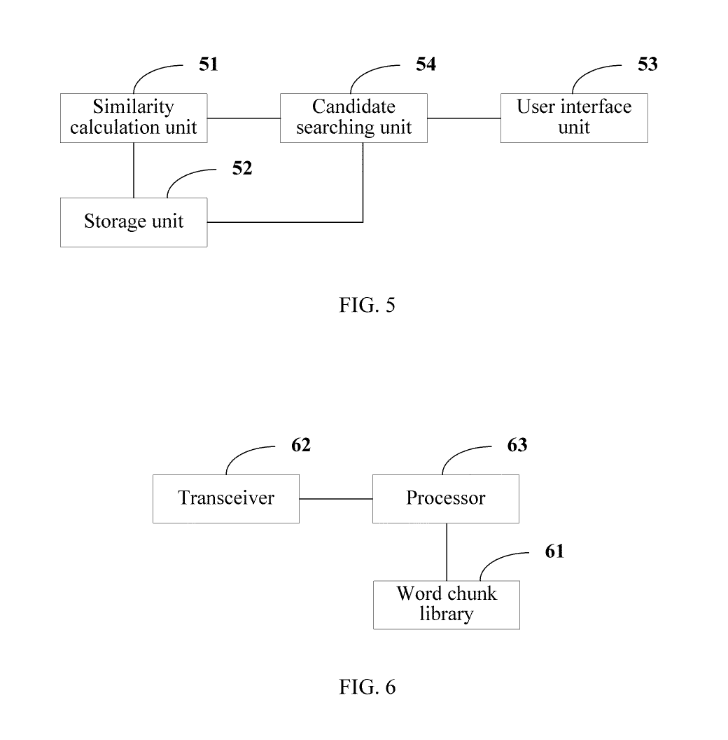

An embodiment of the present disclosure further provides a text editing apparatus. A schematic structural diagram of the text editing apparatus is shown in FIG. 5, and the text editing apparatus includes a similarity calculation unit 51, a storage unit 52, a user interface unit 53, and a candidate searching unit 54, where the similarity calculation unit 51 is configured to calculate semantic and pragmatic similarities of a training text set on a chunk basis to obtain word chunks; the storage unit 52 is configured to store the word chunks obtained through calculation by the similarity calculation unit, where the storage unit may also be referred to as a word chunk library; the user interface unit 53 is configured to acquire a to-be-edited text of a user, segment content in the to-be-edited text into word chunks, and determine a to-be-replaced word chunk in the word chunks; the candidate searching unit 54 is configured to find at least one candidate word chunk similar to the to-be-replaced word chunk, generate a candidate word chunk list, and display the candidate word chunk list; and the user interface unit 53 is further configured to, when an operation instruction that the user selects a candidate word chunk in the displayed candidate word chunk list is acquired, replace the selected candidate word chunk with the to-be-replaced word chunk, to complete text editing.

Optionally, in another embodiment, this embodiment is based on the foregoing embodiment, and the user interface unit is further configured to, when the candidate searching unit finds no candidate word chunk similar to the to-be-replaced word chunk, receive a replacement text that is input by the user, and replace the to-be-replaced word chunk in the word chunks with the replacement text, to complete text editing.

Optionally, the apparatus may be integrated in a server for a terminal, or may be integrated in a mobile terminal, such as a mobile phone.

For details about implementation processes of functions and effects of the units in the apparatus, refer to the implementation processes of the corresponding steps in the foregoing method.

Correspondingly, an embodiment of the present disclosure further provides a server. A schematic structural diagram of the server is shown in FIG. 6, and the server includes a word chunk library 61, a transceiver 62, and a processor 63, where the word chunk library 61 is configured to store word chunks, where the word chunks are obtained by calculating semantic and pragmatic similarities of a training text set on a chunk basis; the transceiver 62 is configured to acquire a to-be-edited text; the processor 63 is configured to segment content in the to-be-edited text into word chunks, and determine a to-be-replaced word chunk in the word chunks; the transceiver 62 is further configured to acquire at least one candidate word chunk similar to the to-be-replaced word chunk; the processor 63 is further configured to generate a candidate word chunk list according to the at least one candidate word chunk acquired by the transceiver, and display the candidate word chunk list; the transceiver 62 is further configured to receive an operation instruction that a user selects a candidate word chunk in the displayed candidate word chunk list; and the processor 63 is further configured to, when the transceiver receives the operation instruction, replace the selected candidate word chunk with the to-be-replaced word chunk, to complete text editing.

Optionally, the transceiver is further configured to, when the candidate searching unit finds no candidate word chunk similar to the to-be-replaced word chunk, receive a replacement text that is input by the user; and the processor is further configured to replace the to-be-replaced word chunk in the word chunks with the replacement text, to complete text editing.

Optionally, the server apparatus may be integrated in a terminal, or may be integrated in a mobile terminal, such as a mobile phone.

For details about implementation processes of functions and effects of the units in the server, refer to the implementation processes of the corresponding steps in the foregoing method.

In the embodiments of the present disclosure, the terminal may be any one of the following, which may be static, or may be mobile. A static terminal may include a mobile station, a subscriber unit, a station, or the like. A mobile terminal may include a cellular phone, a personal digital assistant (PDA), a modem, a wireless communications device, a handheld device, a laptop computer, a cordless phone, a wireless local loop (WLL) station, or the like. The foregoing user equipment (UEs) may be distributed in an entire wireless network.

It should be noted that in the specification, relational terms such as first and second are used only to differentiate an entity or operation from another entity or operation, and do not require or imply that any actual relationship or sequence exists between these entities or operations. Moreover, the terms “include”, “comprise”, or their any other variant is intended to cover a non-exclusive inclusion, so that a process, a method, an article, or a device that includes a list of elements not only includes those elements but also includes other elements that are not explicitly listed, or further includes elements inherent to such process, method, article, or device. An element preceded by “includes a . . . ” does not, without more constraints, preclude the existence of additional identical elements in the process, method, article, or device that includes the element.

Based on the foregoing descriptions of the implementation manners, a person skilled in the art may clearly understand that the present disclosure may be implemented by software in addition to a necessary universal hardware platform or by hardware only. In most circumstances, the former is an exemplary implementation manner. Based on such an understanding, the technical solutions of the present disclosure essentially or the part contributing to the prior art may be implemented in a form of a software product. The software product may be stored in a storage medium, such as a read-only memory (ROM)/random-access memory (RAM), a magnetic disk, or an optical disc, and includes several instructions for instructing a computer device (which may be a personal computer, a server, a network device, or the like) to perform the methods described in the embodiments or some parts of the embodiments of the present disclosure.

The foregoing descriptions are merely exemplary implementation manners of the present disclosure. It should be noted that a person of ordinary skill in the art may make certain improvements or polishing without departing from the principle of the present disclosure and the improvements or polishing shall also fall within the protection scope of the present disclosure.

What is claimed is:

1. A text editing method, comprising:
acquiring a to-be-edited text;
segmenting content in the to-be-edited text into word chunks;
determining a to-be-replaced word chunk in the word chunks;
acquiring at least one candidate word chunk similar to the to-be-replaced word chunk;
generating a candidate word chunk list;
displaying the candidate word chunk list; and
replacing the selected candidate word chunk with the to-be-replaced word chunk to complete text editing when an operation instruction that a user selects a candidate word chunk in the displayed candidate word chunk list is acquired.

2. The method according to claim 1, wherein segmenting the content in the to-be-edited text into word chunks comprises segmenting the content in the to-be-edited text into word chunks according to idioms, common words, and semantic and pragmatic similarities.

3. The method according to claim 1, wherein determining the to-be-replaced word chunk in the word chunks comprises determining the to-be-replaced word chunk in the word chunks according to a received replacement operation instruction of the user.

4. The method according to claim 1, wherein acquiring the at least one candidate word chunk similar to the to-be-replaced word chunk, and generating the candidate word chunk list comprises:
searching a word chunk library for the at least one candidate word chunk similar to the to-be-replaced word chunk;
arranging the searched at least one candidate word chunk together; and
generating the candidate word chunk list.

5. The method according to claim 1, wherein displaying the candidate word chunk list comprises displaying the candidate word chunk list in a text form below the to-be-replaced word chunk.

6. The method according to claim 1, further comprising:
receiving a replacement text that is input by the user when no candidate word chunk similar to the to-be-replaced word chunk is acquired; and
replacing the to-be-replaced word chunk in the word chunks with the replacement text to complete text editing.

7. The method according to claim 1, further comprising:
calculating semantic and pragmatic similarities of a training text set on a chunk basis; and
obtaining corresponding word chunks, wherein the word chunks form the word chunk library.

8. A text editing apparatus, comprising:
a computer processor configured to:
acquire a to-be-edited text;
segment content in the to-be-edited text into word chunks;
determine a to-be-replaced word chunk in the word chunks;
acquire at least one candidate word chunk similar to the to-be-replaced word chunk;
generate a candidate word chunk list according to the at least one candidate word chunk;
display the candidate word chunk list; and
replace the selected candidate word chunk with the to-be-replaced word chunk to complete text editing when an operation instruction that a user selects a candidate word chunk in the candidate word chunk list is acquired.

9. The apparatus according to claim 8, wherein the computer processor is configured to segment the content in the to-be-edited text into word chunks according to idioms and semantic and pragmatic similarities.

10. The apparatus according to claim 8, wherein the computer processor is configured to determine the to-be-replaced word chunk in the word chunks according to a received replacement operation instruction of the user.

11. The apparatus according to claim 8, wherein the computer processor is configured to:
search a word chunk library for the at least one candidate word chunk similar to the to-be-replaced word chunk;
arrange the searched at least one candidate word chunk together; and
generate the candidate word chunk list.

12. The apparatus according to claim 8, wherein the computer processor is configured to display the candidate word chunk list in a text form below the to-be-replaced word chunk.

13. The apparatus according to claim 8, wherein the computer processor is configured to:
receive a replacement text that is input by the user when the computer processor acquires no candidate word chunk similar to the to-be-replaced word chunk; and
replace the to-be-replaced word chunk in the word chunks with the replacement text to complete text editing.

14. The apparatus according to claim 8, wherein the computer processor is configured to store multiple word chunks, wherein the word chunks are obtained by calculating semantic and pragmatic similarities of a training text set on a chunk basis.

15. A text editing apparatus, comprising:
a computer processor configured to:
calculate semantic and pragmatic similarities of a training text set on a chunk basis to obtain word chunks;
store the word chunks obtained through calculation;
acquire a to-be-edited text of a user;
segment content in the to-be-edited text into word chunks;
determine a to-be-replaced word chunk in the word chunks;
find at least one candidate word chunk similar to the to-be-replaced word chunk;
generate a candidate word chunk list;
display the candidate word chunk list; and
replace the selected candidate word chunk with the to-be-replaced word chunk to complete text editing when an operation instruction that the user selects a candidate word chunk in the displayed candidate word chunk list is acquired.

16. The apparatus according to claim 15, wherein computer processor is further configured to:
receive a replacement text that is input by the user when the candidate searching unit finds no candidate word chunk similar to the to-be-replaced word chunk; and
replace the to-be-replaced word chunk in the word chunks with the replacement text to complete text editing.

17. A server, comprising:
a word chunk library configured to store word chunks, wherein the word chunks are obtained by calculating semantic and pragmatic similarities of a training text set on a chunk basis;
a transceiver configured to acquire a to-be-edited text; and
a processor configured to segment content in the to-be-edited text into word chunks, and determine a to-be-replaced word chunk in the word chunks,
wherein the transceiver is further configured to acquire at least one candidate word chunk similar to the to-be-replaced word chunk,
wherein the processor is further configured to generate a candidate word chunk list according to the at least one candidate word chunk acquired by the transceiver, and display the candidate word chunk list,
wherein the transceiver is further configured to receive an operation instruction that a user selects a candidate word chunk in the displayed candidate word chunk list, and
wherein the processor is further configured to replace the selected candidate word chunk with the to-be-replaced word chunk to complete text editing when the transceiver receives the operation instruction.

18. The server according to claim 17, wherein the transceiver is further configured to receive a replacement text that is input by the user when the candidate searching unit finds no candidate word chunk similar to the to-be-replaced word chunk, and wherein the processor is further configured to replace the to-be-replaced word chunk in the word chunks with the replacement text to complete text editing.
